(19) United States
(12) Patent Application Publication
(10) Pub. No.: US 2025/0235950 A1
(43) Pub. Date: Jul. 24, 2025

(54) IMAGING DEVICE, LASER MACHINE TOOL COMPRISING AN IMAGING DEVICE, AND METHOD FOR DETERMINING PROCESS VARIABLES

(71) Applicant: TRUMPF Werkzeugmaschinen SE + Co. KG, Ditzingen (DE)

(72) Inventors: Winfried Magg, Ditzingen (DE); David Schindhelm, Stuttgart (DE); Steffen Keßler, Stuttgart (DE); Manuel Geiger, Möglingen (DE); Alexander Schmid, Marktheidenfeld (DE); Andrea Rüdinger, Gerlingen (DE)

(21) Appl. No.: 19/174,996

(22) Filed: Apr. 10, 2025

Related U.S. Application Data
(63) Continuation of application No. PCT/EP2023/077883, filed on Oct. 9, 2023.

(30) Foreign Application Priority Data
Oct. 11, 2022 (DE) 10 2022 126 278.2

(51) Int. Cl. B23K 26/03; B23K 26/06

(52) U.S. Cl. CPC B23K 26/032; B23K 26/0648

(57) ABSTRACT

An imaging device for imaging a process zone of a laser machine tool includes an image sensor and an optical imaging system. The optical imaging system includes a system axis extending between the image sensor and the process zone, a first aperture spaced radially from the system axis and delimiting first light beams emitted from the process zone at a first imaging angle, a second aperture delimiting second light beams emitted from the process zone at a second imaging angle, and a first imaging lens arranged between the first and/or the second aperture and the image sensor and configured to image the first light beams and the second light beams on the image sensor. The first imaging angle is different from the second imaging angle. The optical imaging system is configured to image the first light beams spatially separately from the second light beams.

### CROSS REFERENCE TO RELATED APPLICATIONS

This application is a continuation of International Application No. PCT/EP2023/077883 (WO 2024/079042 A1), filed on Oct. 9, 2023, and claims benefit to German Patent Application No. DE 10 2022 126 278.2, filed on Oct. 11, 2022. The aforementioned applications are hereby incorporated by reference herein.

### FIELD

Embodiments of the present invention relate to an imaging device having an optical imaging system for imaging a process zone of a laser machine tool onto an image sensor. Embodiments of the present invention also relate to a laser machine tool with an imaging device and a method for determining process variables.

### BACKGROUND

Such devices and methods are known and serve to monitor the laser processing process. Typically, the imaging devices display a three-dimensional image of the process zone on an image sensor as a two-dimensional image. From the analysis of the image of the process zone, important functional and control variables for common laser cutting machines can be derived if the image is sufficiently accurate, which can, for example, support feed control or cutting error detection during laser processing.

WO 2016 062636 A1 describes a device for measuring the depth of a weld seam when welding or joining a workpiece by means of radiation. The device can be inclined relative to a processing beam as a function of a feed speed in order to be able to take into account an inclination of the weld seam depending on the feed speed. However, the representation of the weld seam from only one, albeit variable, angle can only convey insufficient information about the process zone. For example, information may be lost due to a reduced imaging area.

WO 2016 181359 A1 describes a laser processing device having at least one group of detector arrangements. The detector arrangement is arranged in a ring around an optical axis of the laser cutting device. The detector arrangement is designed to detect the process zone at a variety of static angles. The described detector arrangement places considerable structural demands on the implementation of the described principle and requires a complex evaluation routine to evaluate the detected information.

DE 10 2013 218 421 A1 describes a device for monitoring a laser cutting process on a workpiece with an image capture device, wherein an observation beam is formed at an observation angle inclined to the laser beam. The device can also have a plurality of observation directions with the same observation angle.

The aforementioned device does have the possibility of imaging the process zone from different directions, for example by rotating the device. However, the device only images the process zone at a single, predetermined angle. This means that the process zone can only be imaged with inaccuracies. For example, crucial information cannot be imaged by the device at just one predetermined angle. The “geometric visibility” of the process zone typically depends on a nozzle diameter of the laser machine tool, the material thickness of the workpiece to be processed, the distance between the nozzle and the workpiece, and emission properties of the laser processing process.

### SUMMARY

Embodiments of the present invention provide an imaging device for imaging a process zone of a laser machine tool. The imaging device includes an image sensor, and an optical imaging system located between the process zone and the image sensor. The optical imaging system includes a system axis extending between the image sensor and the process zone, and a first aperture spaced radially from the system axis. The first aperture delimits first light beams emitted from the process zone at a first imaging angle. The optical imaging system further includes a second aperture that delimits second light beams emitted from the process zone at a second imaging angle, and a first imaging lens arranged between the first aperture and/or the second aperture and the image sensor. The first imaging lens is configured to image the first light beams and the second light beams on the image sensor. The first imaging angle is different from the second imaging angle. The optical imaging system is configured to image the first light beams spatially separately from the second light beams.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a laser machine tool with a first embodiment of an imaging device in a schematic representation, wherein the imaging device has an image sensor and an optical imaging system;

FIG. 2 shows a second embodiment of the imaging device in a schematic representation;

FIG. 3 shows a third embodiment of the imaging device in a schematic representation;

FIG. 4 shows the image sensor from FIG. 3 in a schematic representation according to some embodiments;

FIG. 5 shows the aperture disc from FIG. 3 in a schematic view according to some embodiments; and

FIG. 6 shows a method according to some embodiments.

### DETAILED DESCRIPTION

Embodiments of the invention provide a device and an associated method for imaging a process zone of a laser processing device, which enable a reliable determination of process variables from the image.

Embodiments of the present invention provide an imaging device. The imaging device is suitable for imaging a process zone of a laser machine tool. Typically, the process zone is imaged optically by imaging light emitted from the process zone.

The imaging device comprises an image sensor. The image sensor is typically designed for two-dimensional imaging of light radiation, preferably in the spectral range from ultraviolet light (UV) to short-wave infrared light (SWIR), particularly preferably from 350 nm to 1800 nm. Preferably, the image sensor is semiconductor-based.

The imaging device also comprises an optical imaging system arranged between the process zone and the image sensor. The optical imaging system is preferably designed to guide and direct the light radiation emitted from the process zone to the image sensor. Further preferably, the optical imaging system is designed to deflect a processing beam of the laser processing device onto a workpiece to be processed.

The optical imaging system has a system axis extending between the image sensor and the process zone. The system axis can be understood as an idealized axis. The idealized axis can replace an optical path commonly used in practice, which can include sections that are inclined to one another. A person skilled in the art would be able to transfer, starting from the system axis, to an optical path in order to structurally enable, for example, an offset between the process zone and the image sensor.

The optical imaging system also has a first aperture that is spaced radially from the system axis. The first aperture is preferably designed perpendicular to the system axis. The first aperture delimits first light beams emitted from the process zone at a first imaging angle. In other words, the first aperture only allows light radiation emitted from the process zone to pass through at a certain angle.

The optical imaging system also has a second aperture. Preferably, the second aperture is designed to be perpendicular to the system axis. The second aperture can be spaced from the first aperture, in particular radially with respect to the system axis. The second aperture delimits the second light beams emitted from the process zone at a second imaging angle.

The optical imaging system also has a first imaging lens arranged between the apertures and the image sensor. In other words, the first imaging lens is arranged in front of the first imaging lens in a beam path of the optical imaging system. As a result, the optical imaging system is designed to integrate additional optical components between the apertures and the first imaging lens. Additional optical components can be integrated into the optical imaging system, for example in the form of optical filters. This allows the optical imaging system to be used to carry out optical measuring procedures, such as stereometry/stereoscopy, quotient pyrometry, goniometry or spectral analysis.

The first imaging lens is typically designed as a convergent lens. The first imaging lens is designed to image at least the first and second light beams on the image sensor.

According to embodiments of the invention, the first imaging angle is different from the second imaging angle. In other words, the first light beams delimited by the first aperture have a different imaging angle than the second light beams delimited by the second aperture. An imaging angle is an angle enclosed between the respective light beam and the system axis. In other words, several light beams can have the same angle value but be emitted in different directions from the process zone. The imaging angle can be zero degrees.

The optical imaging system is further designed to image the first light beams spatially separately from the second light beams. The first light beams and the second light beams are typically imaged on the image sensor.

In other words, the underlying object is achieved in that the imaging device is designed for simultaneous or concurrent imaging of the process zone at at least two different imaging angles, while the remaining light radiation emitted by the process zone is hidden, reflected or absorbed. Furthermore, the process zone is imaged from at least two directed imaging angles, whereby the area of the process zone that can be imaged by the imaging device is increased. Furthermore, the simultaneous imaging of the two light beams occurs spatially separately on the image sensor, thus enabling the images to be assigned to the imaging angles. With knowledge of the imaging angles, the images of the process zone can be used for a geometric comparison. In other words, the process zone can be analyzed three-dimensionally. From a three-dimensional analysis, process variables such as the length of the processing front of the laser machine tool, a space-resolved temperature measurement and/or temperature distribution within the process zone can be reliably determined. This makes it possible, for example, to detect the formation of plasma or metal vapor and to increase the quality of laser processing by avoiding cutting errors.

In a preferred embodiment of the imaging device, the optical imaging system has a directional lens arranged between the process zone and the apertures. The directional lens can align light beams emitted from the process zone parallel to the system axis onto the apertures. In other words, the imaging device can form a collimator. This allows the light beams to be delimited particularly precisely by the apertures.

Another preferred embodiment of the imaging device is one in which the optical imaging device has a third aperture. The third aperture can delimit the third light beams emitted from the process zone at a third imaging angle. An additional aperture can further improve the three-dimensional observation of the process zone.

In a preferred further development of the imaging device, the third imaging angle is different from the first and/or the second imaging angle. This allows an even more precise determination of the process variables.

A further development of the imaging device is particularly preferred in which the optical imaging system is designed to image the third light beams spatially separately from the first and/or the second light beams on the image sensor. Preferably, all light beams are imaged spatially separately from one another on the image sensor. This allows the images to be evaluated with a clear assignment to the respective imaging angles.

In a preferred embodiment of the imaging device, the optical imaging system has a process zone aperture. The process zone aperture can in particular be designed as a processing nozzle of the laser machine tool. This makes it possible to limit the total number of light beams emitted from the process zone in the direction of the imaging device, thereby increasing the imaging accuracy of the light beams.

In a preferred embodiment of the imaging device, the apertures are formed on a common aperture disc. The common aperture disc is preferably arranged vertically or orthogonally to the system axis. A common aperture disc enables a particularly precise spacing of the apertures from one another, in particular when the apertures are moving. Preferably, the aperture disc can be designed as a coated glass substrate. Particularly preferably, the aperture disc transmits light radiation in the area of the apertures and attenuates, absorbs or reflects the light radiation outside the apertures.

In a preferred further development of the imaging device, the aperture disc is designed to be rotatable about the system axis. Preferably, the aperture disc is designed to be rotatable depending on a processing direction of the laser machine tool. This allows the images of the light beams to be maintained in relation to a formation of the process zone that depends on the processing direction. For example, a sharp image of the process zone can be made sharper when the direction of laser processing is changed by 90 degrees, for example, if the aperture disc is also rotated by 90 degrees.

In a preferred further development of the imaging device, the optical imaging system has a first optical rotational decoupling downstream of the first aperture. The first optical rotational decoupling is typically designed independently of a rotation of the aperture disc for positionally accurate imaging of the first light beams on the image sensor. In other words, the first light beams can be imaged on the same imaging area of the image sensor independent of the processing direction of the laser machine tool. This makes it particularly easy to assign the imaging angle to the image. Furthermore, the dimensions of the image sensor can be kept particularly compact.

A further development of the imaging device in which the system axis intersects the image sensor at an imaging intersection is particularly preferred. Preferably, the first imaging lens in this case is designed for centered imaging of the first light beams on the imaging intersection. By imaging the first light beams at the imaging intersection, a stationary imaging of the first light beams can be achieved.

In a particularly preferred further development of the imaging device, in which the system axis runs centrally through the second aperture, the imaging device has at least one optical wedge arranged upstream of the first imaging lens and downstream of the second aperture. In other words, in this case the second aperture delimits the second light beams extending coaxially with the system axis, which are optically independent of any rotation of the second aperture. The optical wedge is preferably designed to deflect the second light beams onto the first imaging lens at an angle relative to the system axis. By deflecting the second light beams, a position of the image on the image sensor can be determined. Preferably, the second light beams are imaged onto an imaging area on the image sensor that is decentered or spaced from the imaging intersection. This allows a position-accurate and rotation-independent imaging of the second light beams without rotational decoupling.

Alternatively, in a further development of the imaging device with a system axis extending centrally through the second aperture, it can be provided that the optical imaging system has a first optical subsystem with a second imaging lens. The first optical subsystem or the second imaging lens is preferably designed for positionally accurate imaging of the second light beams on the image sensor. A second imaging lens can be used to avoid optical superimpositions of the light beams in the first imaging lens, thus increasing the imaging accuracy. By forming an optical subsystem, an optical path with different spectral transmission properties can be provided that is separated from the optical path of the first light beams. This allows the process zone to be imaged with other spectral properties, which can further improve the analysis of the process zone.

A further development of the imaging device is particularly preferred, in which the first optical subsystem has a first deflection mirror downstream of the apertures, wherein the first deflection mirror is designed to deflect second light beams. Preferably, the first deflection mirror is designed for deflecting specific wavelengths of the second light beams. In particular, unwanted wavelengths can be filtered out. This allows the imaging of the second light beams to be particularly precise.

In a preferred further development of the imaging device in conjunction with a third aperture, it can be provided that the optical imaging system has a second optical subsystem downstream of the third aperture. The second optical subsystem is preferably designed for positionally accurate imaging of the third light beams, in particular on the image sensor, independently of a rotation of the aperture disc.

A further development of the imaging device is particularly preferred, in which the second optical subsystem has a second deflection mirror downstream of the apertures. The second deflection mirror is preferably designed for deflecting specific wavelengths of the third light beams. This allows the third light beams to be imaged in a predetermined spectral range.

In a preferred embodiment of the imaging device, the optical imaging system is designed to image the light beams on a single image sensor.

The underlying object is also achieved by a laser machine tool with an imaging device as described above and below.

The laser machine tool typically has a laser processing unit for forming a laser beam. In addition, the laser machine tool typically has a machine control system. The machine control system can be configured to control or regulate the laser processing unit and/or the imaging device.

Preferably, the machine control system has an evaluation unit. The evaluation unit is particularly preferably configured to evaluate the images on the image sensor.

Furthermore, the underlying object is achieved by a method for determining process variables of the process zone by means of the imaging device described above and below. The method has the following method steps:

In one method step, at least a first image and at least a second image of the process zone are created. The images are typically created by the first and second light beams on the image sensor. Preferably, a third image can be generated by the third light beams.

In a further method step, at least the first imaging angle and the second imaging angle are provided. The imaging angles can be provided, for example, by the machine control and/or by an operator of the imaging device.

In a subsequent method step, at least the first image is compared with the second image. Preferably, the geometric contents of the images are compared with each other.

Based on the comparison, at least one process variable is determined or calculated. According to embodiments of the invention, the features mentioned above and those yet to be explained further may be used in each case individually or together in any desired expedient combinations. The embodiments shown and described should not be understood as an exhaustive list, but rather are of an exemplary character.

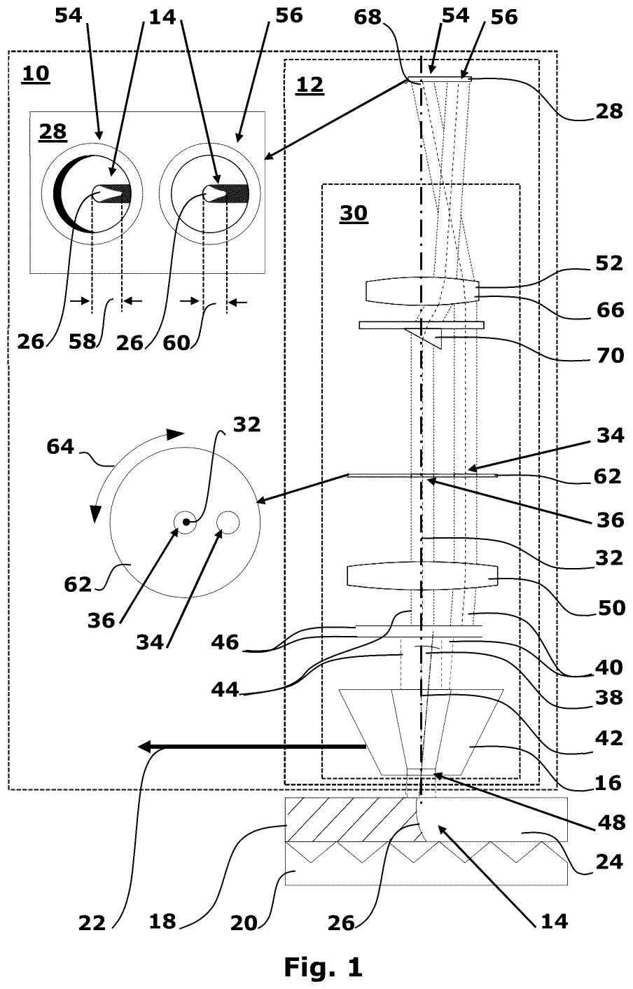

FIG. 1 shows a laser machine tool 10 having an imaging device 12 for imaging a process zone 14 of the laser machine tool 10. In the case shown, the process zone 14 is designed as a processing area or radiation area of a laser beam (not shown in more detail) of the laser machine tool 12.

The laser beam passes through a processing nozzle 16 of the laser machine tool 10 during a machining process in the direction of a workpiece to be processed 18. For better processing, the workpiece 18 can rest on a, preferably web-like, workpiece support 20, as in the case shown. By irradiating the workpiece 18, it can be melted and/or at least partially vaporized in the effective range of the laser beam. If the laser processing machine 10 is moved in a processing direction 22, the workpiece to be processed 18 can be cut along a cutting edge 24, for example. In the transition area between the workpiece 18 and the cutting edge 24, a processing front 26 is formed on the workpiece 18, depending on the radiation duration by the laser beam. Important information about the machining process can be derived from the formation of the processing front 26. The design of the processing front 26 is therefore crucial for controlling or regulating the laser machine tool 10 and must be monitored, for example, to ensure a high processing speed and/or processing quality.

According to the embodiment shown, the imaging device 12 is arranged on the laser machine tool 10, preferably integrated into the laser machine tool 10. The imaging device 12 comprises an image sensor 28 and an optical imaging system 30 arranged between the process zone 14 and the image sensor 28. The optical imaging system 30 is arranged along a system axis 32, which extends between the image sensor 28 and the process zone 14. Preferably, the system axis 32 is designed as the optical axis of the optical imaging system 30. In other words, the optical imaging system 30 can be designed to be at least predominantly rotationally symmetrical to the system axis 32. The system axis 32 is also preferably designed to be orthogonal to the workpiece 18 to be processed. The optical imaging system 30, in particular the entire imaging device 12, can be arranged orthogonally to the workpiece 18 to be machined.

The optical imaging system 30 has a first aperture 34 that is spaced radially from the system axis 32. In addition, the optical imaging system 30 has a second aperture 36. The second aperture 36 is arranged at a distance from the first aperture 34, in particular radially. According to the embodiment shown, the second aperture 36 can be arranged centrally to the system axis 32.

The first aperture 34 delimits the first light beams 40 emitted from the process zone 14 at a first imaging angle 38. The second aperture 36, which delimits the second light beams 44 emitted from the process zone 14 at a second imaging angle 42. The imaging angles 38, 42 can be determined as the inclination of the respective light beams 40, 44 relative to the system axis 32. According to the embodiment shown, the second light beams 44 are emitted parallel to the system axis 32, which is why the second imaging angle 42 here is zero degrees. The first imaging angle 38 is different in size from the second imaging angle 42. Preferably, the first imaging angle is between three degrees and four degrees.

The first light beams 40 and the second light beams 44 are imaged spatially separately on the image sensor 28 by the optical imaging system 30. This allows a perspective view of the process zone 14. The beam paths of the first light beams 40 and the second light beams 44 are shown interrupted by two horizontal lines 46, purely for a more compact representation.

According to the embodiment shown, the optical imaging system 30 may have a process zone aperture 48—here formed on the processing nozzle 16. The process zone aperture 48 delimits the light beams emitted from the process zone 14, for example the first and second light beams 40, 44. This can reduce scattered radiation and improve the imaging of the first and second light beams 40, 44.

The optical imaging system 30 can have a directional lens 50. The directional lens 50 can be arranged between the process zone 14, in particular between the process zone aperture 48, and the first and/or second aperture 34, 36. Preferably, the directional lens 50 aligns the first and/or second light beams 40, 44 emitted from the process zone 14 parallel to the system axis 32. As a result, the imaging device 12 can be kept compact in its dimensions radially to the system axis 32.

The optical imaging system 30 has a first imaging lens 52. The first imaging lens 52 is arranged between the apertures 34, 36 and the image sensor 28. The first imaging lens 52 is typically designed to image the first light beams 40 and/or the second light beams 44 on the image sensor 28. As shown in FIG. 1, the imaging lens 52 forms the first light beams 40 in a first imaging area 54 and the second light beams 44 in a second imaging area 56 on the image sensor 28. The first imaging area 54 is spatially separated from the second imaging area 56.

According to the embodiment, a single image sensor 28 is provided. Alternatively or additionally, the imaging device 12 can have a plurality of image sensors 28 to image the light beams 40, 44. The image sensor 28 and the imaging areas 54, 56 with the first and second light beams 40, 44 imaged on the image sensor 28 are shown in a detailed view as a top view for better explanation.

According to FIG. 1, the first light beams 40 are inclined in the processing direction 22, whereby a “sharp image” of the process zone 14 is produced. In other words, a “sharp image” enables an inclined view of the process zone 14 and the processing front 26 in the processing direction 22. From this, for example, a first length 58 of the processing front 26 dependent on the first imaging angle 38 can be determined.

The second light beams 44 have no inclination to the system axis 32, which results in a “central image” of the process zone 14. In other words, a “central image” enables a central view of the process zone 14 and the processing front 26 independent of the processing direction 22. From this, for example, a second length 60 of the processing front 26 can be determined depending on the second imaging angle 42.

In a geometric comparison of the determined lengths 58, 60 of the processing front 26, further geometric variables of the process zone 14, for example a current penetration depth of the laser beam, can then be determined.

The optical imaging system 30 can have an aperture disc 62. For better explanation, the aperture disc 62 is shown in a further detailed view as a top view. The first aperture 34 and the second aperture 36 can be formed on the (common) aperture disc 62. This facilitates precise positioning of the first aperture 34 relative to the second aperture 36, which has a beneficial effect on the imaging accuracy of the process zone 14.

The aperture disc 62 can, as indicated by the arrow 64, be designed to be rotatable about the system axis 32. This enables the imaging device 12 to be adapted to a changed processing direction 22 of the laser machine tool 10. If, for example, the processing direction 22 shown in FIG. 1 is reversed, the optical imaging system 30 images the process zone 14 contrary to the processing direction 22. This can be prevented by rotating the aperture disc 62 by 180 degrees.

The optical imaging system 30 can, as shown, have a first rotational decoupling 66. The first rotational decoupling 66 is located downstream of the first aperture 34. According to the embodiment shown, the first rotational decoupling 66 is designed as a convergent lens that is rotationally symmetrical about the system axis 32, here in the form of the imaging lens 52. The system axis 32 corresponds to the optical axis of the imaging lens 52. The first rotational decoupling 66 images the first light beams 40 delimited by the first aperture 34 in the imaging area 54 of the image sensor 28. The imaging area 54 is centered on an imaging intersection 68 of the system axis 32 with the image sensor 28, so that the first light beams 40 can be accurately positioned independently of any displacement or rotation of the first diaphragm 34 about the system axis 32 with respect to the system axis 32. In other words, the first light beams 40 can be imaged in the fixed imaging area 54 independent of a rotation of the first aperture 34. The position of the image on the image sensor 28 therefore does not change.

According to the embodiment shown in FIG. 1, the optical imaging system 30 for spatially separated imaging of the second light beams 44 on the image sensor 28 has an optical wedge 70. The optical wedge 70 is designed to direct the second light beams 44 onto the imaging lens 52 at an angle relative to the system axis 32. An inclined illumination of the imaging lens 52 causes the second light beams 44 to be imaged on the image sensor 28 at a radial distance from the imaging intersection 70. Due to the centered arrangement of the second aperture 36 on the system axis 32, a positionally accurate imaging of the second light beams 44 can take place in the imaging area 56 of the image sensor 28 independent of a rotation of the second aperture 36 about the system axis 32. In this embodiment, rotational decoupling can be omitted.

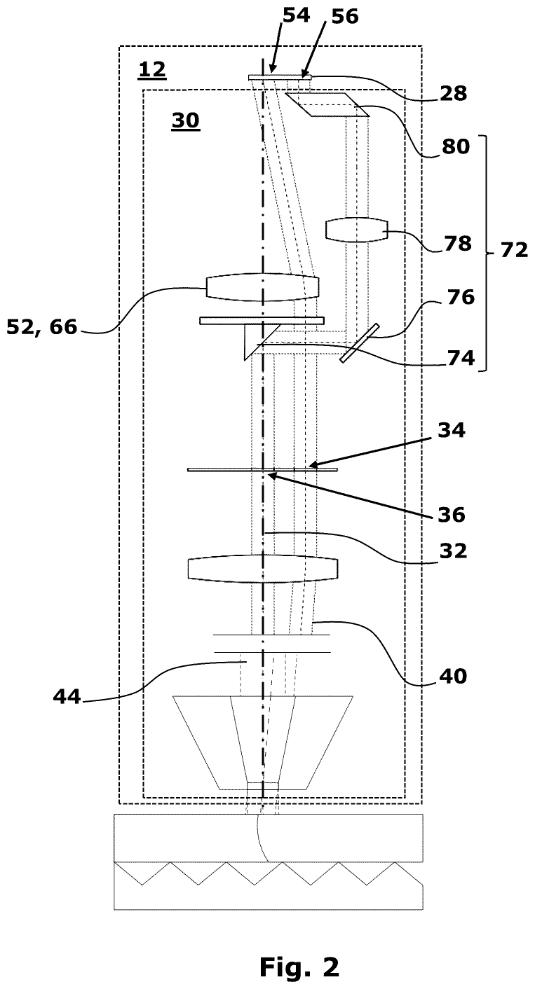

FIG. 2 shows a second embodiment of the imaging device 12 in a schematic representation. An optical imaging system 30 has a first rotational decoupling 66, which enables a rotation-independent and positionally accurate imaging of first light beams 40 in the imaging area 54 on an image sensor 28 by means of a first imaging lens 52.

In addition, the optical imaging system 30 has a first optical subsystem 72. The optical subsystem 72 is designed to image the second light beams 44 on the image sensor 28 spatially separately from the first light beams 40. According to the embodiment shown, the first optical subsystem 72 has a first deflection mirror 74, a second deflection mirror 76, a second imaging lens 78 and an imaging prism 80.

The first deflection mirror 74 is arranged between the apertures 34, 36 and the first imaging lens 52 and is configured to deflect second light beams 44. As shown, the second light beams 44 can be directed by the first deflection mirror 74 past the first imaging lens 52 to a second deflection mirror 76.

The second deflection mirror 76 can be designed to align the second light beams 44. Preferably, the second deflection mirror 76 aligns the second light beams 44 parallel to the system axis 32. In other words, the deflection mirrors 74, 76 cause a parallel displacement of the second light beams 44 or a radial spacing of the second light beams 44 from the system axis 32.

The second light beams 44 can then be imaged on the image sensor 28 by means of the second imaging lens 78, whereby the image quality can be improved.

In order to keep the dimensions of the image sensor 28 small, it can be provided, as shown, that the radial spacing caused by the deflection mirrors 74, 76 is partially or completely compensated by the imaging prism 80.

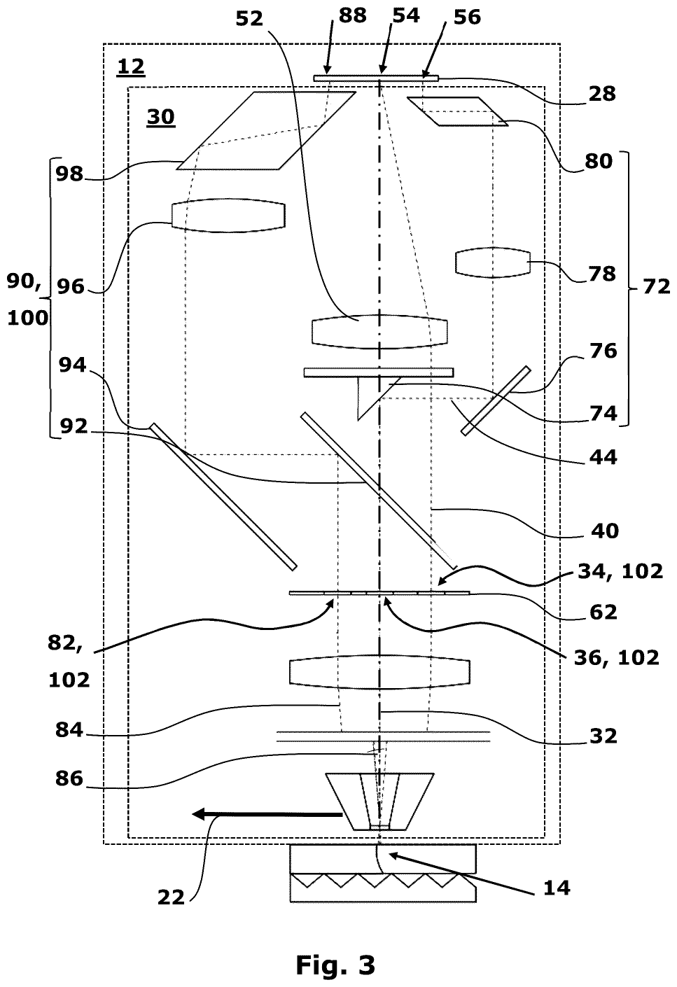

FIG. 3 shows a third embodiment of the imaging device 12 in a schematic representation.

An optical imaging system 30 has a first aperture 34 that is spaced radially from the system axis 32, a second aperture 36 and a third aperture 82. The apertures 34, 36, 82 can be designed on a common aperture disc 62.

First light beams 40 delimited by the first aperture 34 are imaged by means of an imaging lens 52 in a first imaging area 54 on an image sensor 28. Second light beams 44 are imaged on the image sensor 28 by means of a first optical subsystem 72 or a second imaging lens 78 in a second imaging area 56, analogous to FIG. 2.

The third aperture 82 can be arranged at a distance from the first aperture 34 and/or from the second aperture 36, in particular at a radial distance. The third aperture 36 is typically designed to delimit third light beams 84, which are emitted at a third imaging angle 86 from the process zone 14. The third imaging angle 86 can be inclined opposite to the processing direction 22. The optical imaging system 30 is designed to image the third light beams 84 on the image sensor 28, in particular in a third imaging area 88.

The optical imaging system 30 can, as shown, have a second optical subsystem 90 configured to image the third light beams 84 on the image sensor 28. The second optical subsystem 90 can have a third deflection mirror 92, a fourth deflection mirror 94, a third imaging lens 96 and a second imaging prism 98.

The second optical subsystem 90 can be configured analogously to the first optical subsystem 72 for radially spacing the third light beams 84. For this purpose, a deflection of the first light beams 84 from a direction parallel to the system axis 32 with subsequent renewed parallel alignment relative to the system axis 32 of the deflected third light beams 84 can be provided. An image of the third light beams 84 can thus be produced in a positionally accurate manner via the third imaging lens 96 and the imaging prism 98 in the, in particular stationary, third imaging area 88.

According to the embodiment shown in FIG. 3, the second optical subsystem 90 is also designed as a second rotational decoupling 100. This enables the positionally accurate imaging of the third light beams 84 even when the third aperture 82 or the aperture disc 62 is rotated.

The third deflection mirror 92 of the second optical subsystem 90 can be designed to be rotationally symmetrical to the system axis 32 in a plane orthogonal to the system axis 32. The third deflection mirror 92 can be circular in the plane orthogonal to the system axis 32, wherein the inner diameter is smaller than a smallest distance of the third aperture 82 from the system axis 32 and wherein the outer diameter is greater than a maximum distance of the third aperture 82 from the system axis 32. Preferably, the deflection mirror 92 is designed as a circumferential circular ring in the plane orthogonal to the system axis 32. In other words, the deflection mirror 92 has dimensions in the plane projected towards the system axis 32 that correspond at least to the circumferential projection surface of the third aperture 82. This maximizes independence from the rotation of the third aperture 82. A circular ring-like design of the third deflection mirror 92 allows the first light beams 40 and the second light beams 44 to pass optically unhindered if the apertures 34, 36, 82 each have radially spaced-apart circumferential projection surfaces-in other words, if the circumferential projection surfaces of the apertures 34, 36, 82 do not overlap.

Alternatively, as shown in FIG. 3, it can be provided that the deflection mirror 92 is designed to deflect light beams in a predetermined wavelength range, wherein light beams outside the predetermined wavelength range are transmitted. For this purpose, it can be provided that at least one optical bandpass filter 102 is connected in front of the deflection mirror 92. Preferably, the apertures 34, 36, 82 each have an optical bandpass filter 102 which predetermines the wavelength range of the respective light beams 40, 44, 84. This allows light beams 40, 44, 84, which have overlapping circumferential projection surfaces, to be optically separated.

It is also possible to record further information based on polarization properties. For this purpose, it can be provided that at least one of the apertures 34, 36, 82 has a polarization filter, for example for filtering s-polarized and p-polarized light beams, as an alternative or in addition to the optical bandpass filter 102. By means of a polarization filter, correspondingly “polarized” images can be displayed and/or used for measurement purposes.

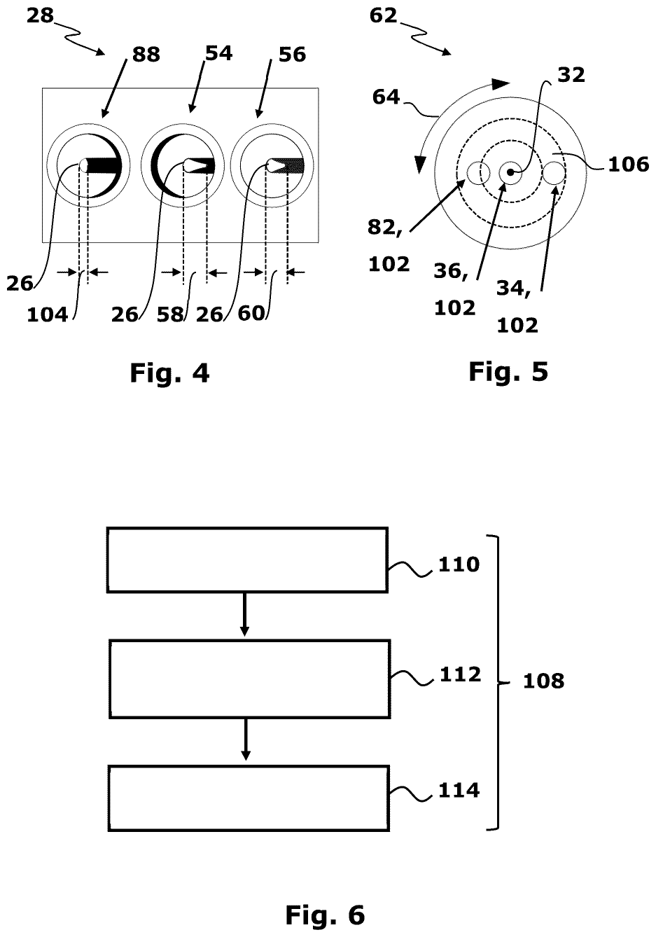

FIG. 4 shows the image sensor 28 from FIG. 3 in a schematic view. Imaging areas 54, 56, 88 are spatially spaced apart from one another and arranged in a fixed position on the image sensor 28. In other words, the positions of the imaging areas 54, 56, 88 on the image sensor 28 do not change when the processing direction 22 (see FIG. 1) or the rotational position of the aperture disc 62 (see FIGS. 1-3, 5) is changed.

The first imaging area 54 shows a “sharp image” of the process zone 14 (see FIG. 1), whereby, for example, the first length 58 of the processing front 26, which is dependent on the first imaging angle 38 (see FIG. 1), can be determined. Furthermore, the second imaging area 56 shows a “centered image” of the process zone 14, whereby, for example, a second length 60 of the processing front 26 dependent on the second imaging angle 42 (see FIG. 1) can be determined. In addition, the third imaging area 88 shows a “dull representation” of the process zone 14 (see FIG. 3) against the processing direction 22 (see FIG. 3) caused by the third imaging angle 86, whereby, for example, a third length 104 of the processing front 26 can be determined.

The additional information about the third image can further improve the determination of geometric dimensions of the process zone 14.

FIG. 5 shows the aperture disc 62 from FIG. 3 in a schematic view.

The aperture disc 62 is designed to be rotatable about the system axis 32, as indicated by the arrow 64. The apertures 34, 36, 82 are formed spatially separately from one another on the aperture disc 62. The second aperture 36 is formed centrally to the system axis 32 on the aperture disc 62.

The first aperture 34 and the third aperture 82 are offset by 180 degrees on the aperture disc 62 and have different radial distances from the system axis 32.

A track 106, indicated by a dashed circular ring, of the first aperture 34 overlaps with the third aperture 82. This can lead to optical superpositions of the first and third light beams 40, 84, which makes the images on the image sensor 28 (FIGS. 1-4) unclear. In order to avoid optical superposition, it can be provided that the apertures 34, 36, 82, here in particular the first and the third aperture 34, 82, have an optical bandpass filter 102.

FIG. 6 schematically shows a method 108 for determining, in particular geometric, process variables of a process zone 14 (see FIG. 1) by means of an imaging device 12 (see FIG. 1).

The method 108 has the following method steps (see also FIG. 1 below).

In one method step 110, a first image and a second image of the process zone 14 are created. The first and second images are typically created by imaging first and second light beams 40, 44 in first and second imaging areas 54, 56 of an image sensor 28.

In a further method step 112, the first imaging angle 38 and a second imaging angle 42 are provided.

A subsequent method step 114 provides for the geometric comparison of the first image with the second image, wherein at least one process variable is determined or calculated by the geometric comparison.

As described above, embodiments of the invention relate to an imaging device (12) for imaging a process zone (14) of a laser machine tool (10), said imaging device comprising an image sensor (28) and an optical imaging system (30) located between the process zone (14) and the image sensor (28). The optical imaging system (30) has a system axis (32) extending between the image sensor (28) and the process zone (14), a first aperture (34) radially spaced from the system axis (32) and a second aperture (36). Light beams (40, 44) emitted from the process zone (14) at different imaging angles (38, 42) are delimited by the apertures (34, 36). The optical imaging system (30) is designed to image the first light beams (40) spatially separately from the second light beams (44). Embodiments of the invention also relate to a laser machine tool (10) with an imaging device (12) and a method for determining process variables.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SYMBOLS

10 Laser machine tool
12 Imaging device
14 Process zone
16 Processing nozzle
18 Workpiece
20 Workpiece support
22 Processing direction
24 Cutting edge
26 Processing front
28 Image sensor
30 Optical imaging system
32 System axis
34 First aperture
36 Second aperture
38 First imaging angle
40 First light beams
42 Second imaging angle
44 Second light beams
46 Horizontal lines
48 Process zone aperture
50 Directional lens
52 First imaging lens
54 First imaging area
56 Second imaging area
58 First length
60 Second length
62 Aperture disc
64 Arrow
66 First rotational decoupling
68 Imaging intersection
70 Optical wedge
72 First optical subsystem
74 First deflection mirror
76 Second deflection mirror
78 Second imaging lens
80 Imaging prism
82 Third aperture
84 Third light beams
86 Third imaging angle
88 Third imaging area
90 Second optical subsystem
92 Third deflection mirror
94 Fourth deflection mirror
96 Third imaging lens
98 Second imaging prism
100 Second rotational decoupling
102 Optical bandpass filter
104 Third length
106 Track
108 Method
110 Method step
112 Method step
114 Method step

1. An imaging device for imaging a process zone of a laser machine tool, the imaging device comprising:
an image sensor; and
an optical imaging system located between the process zone and the image sensor;
wherein the optical imaging system comprises:
a system axis extending between the image sensor and the process zone;
a first aperture spaced radially from the system axis, the first aperture delimiting first light beams emitted from the process zone at a first imaging angle;
a second aperture delimiting second light beams emitted from the process zone at a second imaging angle; and
a first imaging lens arranged between the first aperture and/or the second aperture and the image sensor, wherein the first imaging lens is configured to image the first light beams and the second light beams on the image sensor;
wherein the first imaging angle is different from the second imaging angle, and wherein the optical imaging system is configured to image the first light beams spatially separately from the second light beams.

2. The imaging device according to claim 1, wherein the optical imaging system further comprises a directional lens arranged between the process zone and the first aperture and/or the second aperture, wherein the directional lens is configured to direct the first light beams and the second light beams emitted by the process zone parallel to the system axis onto the first aperture and the second aperture, respectively.

3. The imaging device according to claim 1, wherein the optical imaging system comprises a third aperture delimiting third light beams emitted from the process zone at a third imaging angle.

4. The imaging device according to claim 3, wherein the third imaging angle is different from the first imaging angle and/or the second imaging angle.

5. The imaging device according to claim 3, wherein the optical imaging system is configured to image the third light beams spatially separately from the first light beams and/or the second light beams on the image sensor.

6. The imaging device according to claim 1, wherein the optical imaging system comprises a process zone aperture for delimiting the first light beams and/or the second light beams emitted by the process zone.

7. The imaging device according to claim 1, wherein the first aperture and the second aperture are disposed on a common aperture disc.

8. The imaging device according to claim 7, wherein the aperture disc is configured to be rotatable about the system axis.

9. The imaging device according to claim 8, wherein the optical imaging system comprises a first optical rotational decoupling downstream of the first aperture, wherein the first optical rotational decoupling is configured independently of a rotation of the aperture disc for positionally accurate imaging of the first light beams on the image sensor.

10. The imaging device according to claim 9, wherein the system axis intersects the image sensor at an imaging intersection, and wherein the first imaging lens is configured for centered imaging of the first light beams on the imaging intersection.

11. The imaging device according to claim 8, wherein the system axis extends centrally through the second aperture, wherein the optical imaging system further comprises an optical wedge located in front of the first imaging lens, wherein the optical wedge is configured to deflect the second light beams onto the first imaging lens at an angle relative to the system axis.

12. The imaging device according to claim 8, wherein the system axis extends centrally through the second aperture, wherein the optical imaging system further comprises a first optical subsystem with a second imaging lens, wherein the second imaging lens is configured for positionally accurate imaging of the second light beams.

13. The imaging device according to claim 12, wherein the first optical subsystem comprises a first deflection mirror downstream of the first aperture and/or the second aperture, wherein the first deflection mirror is configured for deflecting specific wavelengths of the second light beams.

14. The imaging device according to claim 3, wherein the optical imaging system comprises a second optical subsystem downstream of the third aperture and a third imaging lens, wherein the third imaging lens is configured for positionally accurate imaging of the third light beams.

15. The imaging device according to claim 14, wherein the second optical subsystem is configured as a second optical rotational decoupling, wherein the second optical rotational decoupling is configured for positionally accurate imaging of the third light beams.

16. The imaging device according to claim 15, wherein the second optical rotational decoupling comprises a third deflection mirror downstream of the first aperture and/or the second aperture, wherein the third deflection mirror is configured for deflecting specific wavelengths of the third light beams.

17. The imaging device according to claim 1, wherein the image sensor comprises a single image sensor, wherein the optical imaging system is configured to image the first light beams and the second light beams on the single image sensor.

18. A laser machine tool having an imaging device according to claim 1.

19. A method for determining process variables of a process zone by using an imaging device according to claim 1, the method comprising:
creating a first image and a second image of the process zone;
providing the first imaging angle and the second imaging angle;
geometrically comparing the first image with the second image; and
determining at least one process variable based on the geometric comparison.
